(19) United States
(12) Patent Application Publication
(10) Pub. No.: US 2026/0231113 A1
(43) Pub. Date: Aug. 6, 2026

(54) METHODS, COMMUNICATIONS DEVICES, AND INFRASTRUCTURE EQUIPMENT

(71) Applicant: Sony Group Corporation, Tokyo (JP)

(72) Inventors: Vivek SHARMA, Surrey (GB); Yuxin WEI, Basingstoke (GB); Yassin Aden AWAD, Uxbridge (GB); Hideji WAKABAYASHI, Hampshire (GB)

(73) Assignee: Sony Group Corporation, Tokyo (JP)

(21) Appl. No.: 19/150,202

(22) PCT Filed: Feb. 6, 2024
(86) PCT No.: PCT/EP2024/052928

§ 371 Date: Jul. 23, 2025

(30) Foreign Application Priority Data
Feb. 13, 2023 (EP) 23156388.3

(51) Int. Cl. H04W 68/02; H04W 92/18

(52) U.S. Cl. CPC H04W 68/02; H04W 92/18

(57) ABSTRACT

A method of operating a first communications device is provided. The method comprises transmitting, to a second communications device operating as a relay device to which the first communications device is connected via a sidelink communications interface, an indication of at least one of a Paging Early Indication, PEI, subgroup of the first communications device and a PEI capability of the first communications device. Here, the PEI subgroup of the first communications device indicates paging occasions before which the first communications device is configured to monitor for PEI signals, the PEI signals each indicating whether the first communications device is to monitor for paging signals during the paging occasion following that PEI, and the PEI capability of the first communications device indicates one or more frequency bands within which the first communications device is able to receive PEI signals.

### BACKGROUND

### Field of Disclosure

The present disclosure relates to communications devices, infrastructure equipment and methods for the more effective and efficient performance of paging for remote communications devices connected to sidelink relays.

The present application claims the Paris Convention priority from European patent application number EP 23156388.3, filed on 13 Feb. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a first communications device. The method comprises transmitting, to a second communications device operating as a relay device to which the first communications device is connected via a sidelink communications interface, an indication of at least one of a Paging Early Indication, PEI, subgroup of the first communications device and a PEI capability of the first communications device. Here, the PEI subgroup of the first communications device indicates paging occasions before which the first communications device is configured to monitor for PEI signals, the PEI signals each indicating whether the first communications device is to monitor for paging signals during the paging occasion following that PEI, and the PEI capability of the first communications device indicates one or more frequency bands within which the first communications device is able to receive PEI signals.

Embodiments of the present technique, which, in addition to methods of operating a first communications device, relate to methods of operating a second communications device as a relay device and infrastructure equipment, to (first and second) communications devices and infrastructure equipment, circuitry for (first and second) communications devices and infrastructure equipment, communications systems, computer programs, and computer-readable storage mediums, can allow for the more effective and efficient performance of paging for remote communications devices connected to sidelink relays.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (NR) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents a time line associated with paging occasions in wireless telecommunication systems based on known approaches;

FIG. 5 shows a message flow diagram illustrating an example of a core network based sup-grouping technique;

FIG. 6 shows a message flow diagram illustrating an example of paging early indication (PEI) and paging area signalling;

FIG. 7 shows a part schematic, part message flow diagram representation of a communications system comprising a communications device and an infrastructure equipment in accordance with embodiments of the present technique;

FIG. 8 illustrates a deployment scenario with different PEI capabilities for different UEs in accordance with embodiments of the present technique;

FIG. 9 shows a flow diagram illustrating a first example process of communications in a communications system in accordance with embodiments of the present technique; and

FIG. 10 shows a flow diagram illustrating a second example process of communications in a communications system in accordance with embodiments of the present technique.

### DETAILED DESCRIPTION OF THE EMBODIMENTS

### Long Term Evolution Advanced Radio Access Technology (4G)

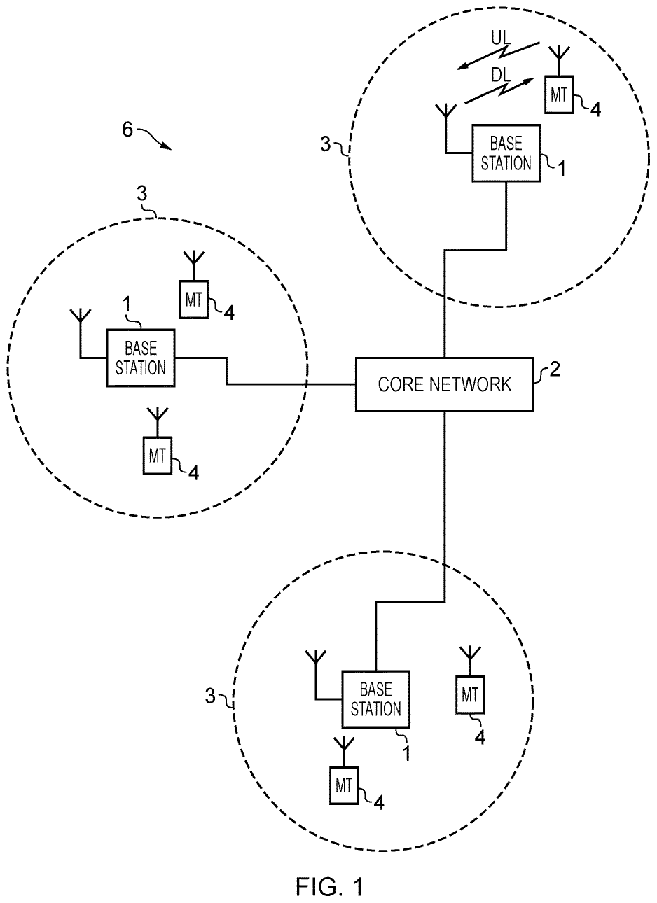

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Communications devices may also be referred to as mobile stations, user equipment (UEs), user terminals, mobile radios, terminal devices, wireless transmit and receive units (WTRUs), and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

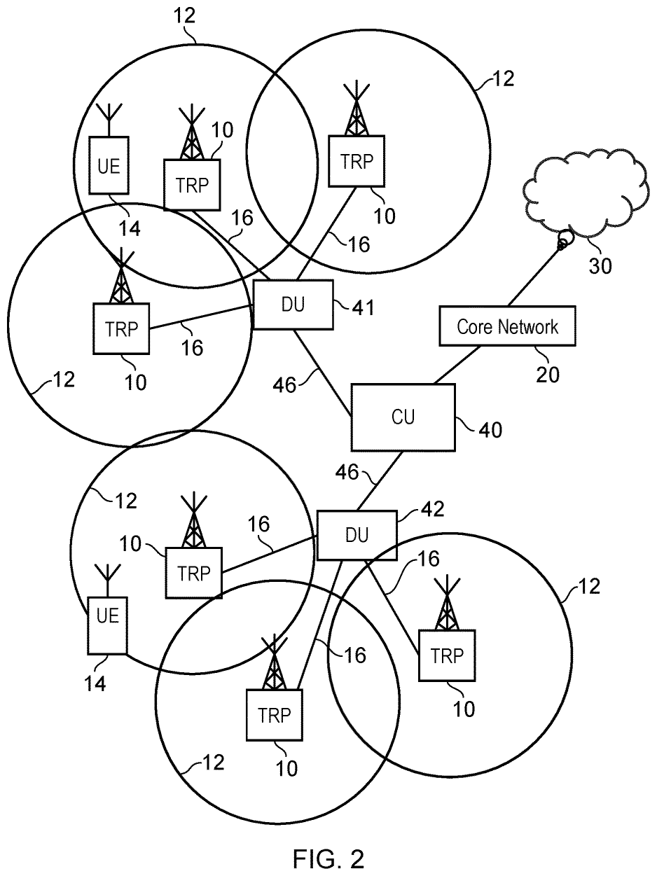

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

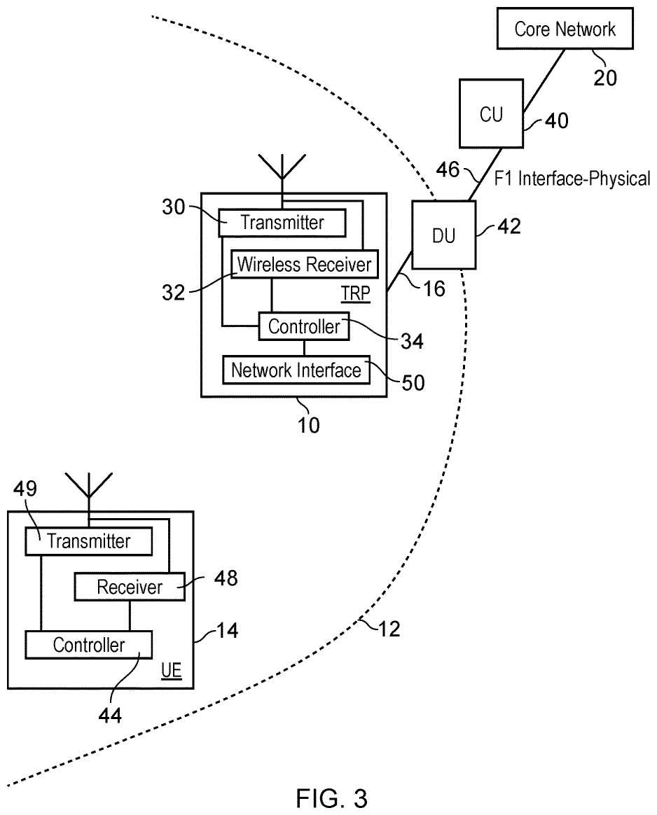

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 [3] and 3GPP TS 38.473 [4], and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Known Paging Techniques

As is well understood, various wireless telecommunications networks, such as the LTE-based network represented in FIG. 1 and the NR-based network represented in FIG. 2, may support different Radio Resource Control (RRC) modes for terminal devices, typically including: (i) RRC idle mode (RRC_IDLE); and (ii) RRC connected mode (RRC_CONNECTED). When a terminal device transmits data, RRC connected mode is generally used. The RRC idle mode, on the other hand, is for terminal devices which are registered to the network (EMM-REGISTERED), but not currently in active communication (ECM-IDLE). Thus, generally speaking, in RRC connected mode a terminal device is connected to a radio network access node (e.g. an LTE base station) in the sense of being able to exchange user plane data with the radio network access node. Conversely, in RRC idle mode a terminal device is not connected to a radio network access node in the sense of not being able to communicate user plane data using the radio network access node. In idle mode the terminal device may still receive some communications from base stations, for example reference signalling for cell reselection purposes and other broadcast signalling. The RRC connection setup procedure of going from RRC idle mode to RRC connected mode may be referred to as connecting to a cell/base station.

For a terminal device in RRC idle mode the core network is aware that the terminal device is present within the network, but the radio access network (RAN) part (comprising radio network infrastructure equipment such as the base stations 1 of FIG. 1 and/or the TRPs 10 of FIG. 2) is not. The core network is aware of the location of idle mode terminal devices at a paging tracking area level but not at the level of individual transceiver entities. The core network will generally assume a terminal device is located within the tracking area(s) associated with a transceiver entity most recently used for communicating with the terminal device, unless the terminal device has since provided a specific tracking area update (TAU) to the network. (As is conventional, idle mode terminal devices are typically required to send a TAU when they detect they have entered a different tracking area to allow the core network to keep track of their location.) Because the core network tracks terminal devices at a tracking area level, it is generally not possible for the network infrastructure to know which specific transceiver entities (radio network node) to use when seeking to initiate contact with a terminal device in idle mode. Consequently, and as is well known, when a core network is required to connect to an idle mode terminal device a paging procedure is used.

In a typical currently deployed network, idle mode terminal devices are configured to monitor for paging messages periodically. For terminal devices operating in a discontinuous reception (DRX) mode this occurs when they wake up for their DRX awake time. Paging signals for a specific terminal device are transmitted in defined frames (Paging Frames)/sub-frames (Paging Occasions) which for a given terminal device may be derived from the International Mobile Subscriber Identifier (IMSI) of the terminal device, as well as paging related DRX parameters established in system information transmitted within the network.

In a conventional system, a terminal device thus receives and checks the contents of specific sub-frames (paging occasions) in specific frames (paging frames) to look for paging signalling. For example, in accordance with the standards set out in [5], a Paging Frame (PF) is a downlink radio frame which may contain one or more Paging Occasion(s) (PO), where a Paging Occasion is a sub-frame where there may be P-RNTI transmitted on PDCCH (or equivalent channel depending on implementation, e.g. on MPDCCH for MTC or for NB-IOT on NPDCCH) addressing the paging message. Paging messages are conveyed on a physical downlink shared channel (PDSCH) on resources identified from an allocation message addressed to a paging radio network temporary identifier (P-RNTI) and conveyed on a physical downlink control channel (PDCCH). P-RNTI is a common identifier for all terminal devices (e.g. set at FFFE in hexa-decimal for the standard defined by [6]). All terminal devices check whether PDCCH at specific PFs/POs configured for their use include P-RNTI or not. If there is a PDSCH allocation addressed to P-RNTI in the relevant subframe, the terminal device proceeds to seek to receive and decode the paging messages transmitted on the allocated resources on PDSCH. The UE then checks the list of IDs contained in the paging record list in the received paging message, to determine whether the list contains an ID corresponding to itself (for example P-TMSI or IMSI), and if so initiates a paging response.

Although the above description has summarised an example existing LTE paging procedure, it is expected that broadly similar principles may be adopted for future wireless telecommunications networks based on newer radio access technologies (RATs), such as 5G networks. The above-description of a paging procedure has referred to specific channel names which are commonly used in LTE, such as PDCCH and PDSCH, and this terminology will be used throughout this description for convenience, it being appreciated that in certain implementations different channel names may be more common. For example in the context of a wireless telecommunications system having dedicated channels for communicating with certain types of terminal devices, for example MTC devices, it may be expected the corresponding channel names may be modified. For example, a physical downlink control channel dedicated for MTC devices may be referred to as MPDCCH and a corresponding physical downlink shared channel for MTC devices may be referred to as PDSCH.

In approaches for eNB-IoT and feMTC in accordance with 3GPP Release 14, a terminal device in DRX in idle mode is required to decode PDCCH (or equivalent downlink control channel for the specific implementation at hand) to identify if there are resources scheduled on PDSCH (or equivalent downlink shared channel for the specific implementation at hand) for a paging message during paging occasions in which the terminal device might receive a paging message.

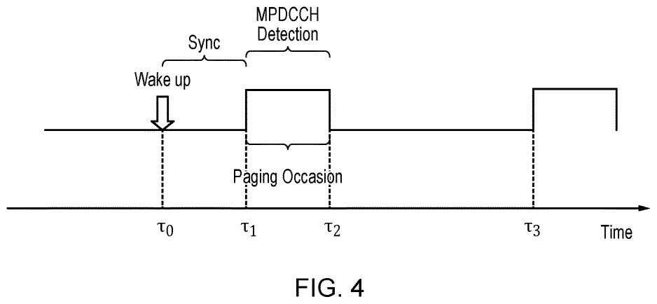

FIG. 4 schematically represents a timeline of a paging occasion for a terminal device operating in a known wireless telecommunications system. In the example shown in FIG. 4, one paging occasion is shown and extends from time t1 to t2. As is conventional, paging occasions for a terminal device will typically occur according to a regular repeating schedule having regard to the terminal device's currently configured DRX cycle. Different terminal devices may have different DRX cycle lengths, and so have different times between paging occasions. For a terminal device having a relatively long DRX cycle/time between paging occasions, it is possible the terminal device will to some extent lose synchronisation with the radio network infrastructure equipment of the telecommunications system between paging occasions. In this case it may be helpful for the terminal device to wake up in advance of the paging occasion to allow it to synchronise to the wireless telecommunications system prior to the paging occasion. An example of this is schematically shown in FIG. 4 in which the terminal device wakes up at time t0 so that it can synchronise with the wireless telecommunication system in the period between times t0 and t1 so that it is able to monitor/detect MPDCCH during the configured paging occasion between t1 and t2. In this regard, the process of synchronisation might in some cases only require fine adjustments to frequency and/or timing tracking loops based on detection of CRS (cell-specific reference symbols), e.g. when DRX cycles (times between paging occasions) are relatively short, or a more significant degree of synchronisation may be needed, for example complete re-synchronisation by detecting PSS/SSS (primary synchronisation signals/secondary synchronisation signals) as well as using CRS, e.g. when DRX cycles (times between paging occasions) are relatively long (such that the frequency and timing of the terminal device may become significantly offset relative to that of the radio network infrastructure).

Once the terminal device has re-synchronised to the network, it will monitor MPDCCH to determine if there is a paging message, and if so will go on to decode the PDSCH carrying the paging message in the usual way. If there is no paging message for the terminal device, the terminal device will go back to sleep (low power mode) until the next paging occasion. For certain types of terminal devices, such as MTC devices, it may be expected that paging will occur relatively rarely (e.g. once per day for a smart utility meter)

### RRC Inactive State and RAN Notification Area

The following text and description of RRC_INACTIVE (also termed herein the RRC Inactive state or simply inactive state) and the RAN notification area (RNA) is loosely adapted from [7], and is provided here so as to give a background on RRC_INACTIVE. It should be appreciated that those skilled in the art would have a complete understanding on RRC_INACTIVE, including transition processes between this state and RRC_CONNECTED (also termed herein the RRC Connected state or simply connected state), and the RAN notification area update (RNA), as described in [7], among other documents.

RRC INACTIVE is a state where a UE remains in the connection management connected (CM-CONNECTED) state and can move within an area configured by the NextGen Radio Access Network (NG-RAN)—this area being the RNA—without notifying NG-RAN. In RRC_INACTIVE, the last serving gNodeB node keeps the UE context and the UE-associated NG connection with the serving access and mobility management function (AMF) and user plane function (UPF).

If the last serving gNodeB receives downlink data from the UPF or downlink UE-associated signalling from the AMF (except the UE Context Release Command message) while the UE is in RRC_INACTIVE, it pages in the cells corresponding to the RNA and may send XnAP RAN Paging to neighbour gNodeB(s) if the RNA includes cells of neighbour gNodeB(s).

Upon receiving the UE Context Release Command message while the UE is in RRC_INACTIVE, the last serving gNodeB may page in the cells corresponding to the RNA and may send Xn Application Protocol (XnAP) RAN Paging to neighbour gNodeB(s) if the RNA includes cells of neighbour gNodeB(s), in order to release the UE explicitly.

The AMF provides to the NG-RAN node the RRC Inactive Assistance Information to assist the NG-RAN node's decision as to whether the UE can be controlled to transition to RRC INACTIVE. The RRC Inactive Assistance Information includes the registration area configured for the UE, the UE specific discontinuous reception (DRX) configuration, Periodic Registration Update timer, an indication if the UE is configured with Mobile Initiated Connection Only (MICO) mode by the AMF, and UE Identity Index value. The UE registration area is taken into account by the NG-RAN node when configuring the RNA. The UE specific DRX configuration and UE Identity Index value are used by the NG-RAN node for RAN paging. The Periodic Registration Update timer is taken into account by the NG-RAN node to configure Periodic RNA Update timer.

At transition to RRC INACTIVE the NG-RAN node may configure the UE with a periodic RNA Update timer value. If the UE accesses a gNodeB other than the last serving gNodeB, the receiving gNodeB triggers the XnAP Retrieve UE Context procedure to get the UE context from the last serving gNodeB and may also trigger a Data Forwarding procedure including tunnel information for potential recovery of data from the last serving gNodeB. Upon successful UE context retrieval, the receiving gNodeB performs the slice-aware admission control in case of receiving slice information and becomes the serving gNodeB and it further triggers the NG application protocol (NGAP) Path Switch Request and RRC procedures properly. After the path switch procedure, the serving gNodeB triggers release of the UE context at the last serving gNodeB by means of the XnAP UE Context Release procedure.

In case the UE is not reachable at the last serving gNodeB, the gNodeB fails AMF initiated UE-associated class 1 procedures if any, and triggers the Non-Access Stratum (NAS) Non Delivery Indication procedure to report the non-delivery of any NAS PDU received from the AMF for the UE. If the UE accesses a gNodeB other than the last serving gNodeB and the receiving gNodeB does not find a valid UE Context, the receiving gNodeB can perform establishment of a new RRC connection instead of resumption of the previous RRC connection.

A UE in the RRC_INACTIVE state is required to initiate RNA update procedure when it moves out of the configured RNA. When receiving RNA update request from the UE, the receiving gNodeB triggers the XnAP Retrieve UE Context procedure to get the UE context from the last serving gNodeB and may decide to send the UE back to RRC INACTIVE state, move the UE into RRC_CONNECTED state, or send the UE to RRC IDLE.

A UE in RRC_INACTIVE performs cell reselection. A UE in the RRC_INACTIVE state can be configured by the last serving NG-RAN node with an RNA, where:
the RNA can cover a single or multiple cells, and is contained within the CN registration area; (in [7] it is stated that Xn connectivity should be available within the RNA); and
a RAN-based notification area update (RNAU) is periodically sent by the UE and is also sent when the cell reselection procedure of the UE selects a cell that does not belong to the configured RNA.

There are several different alternatives on how the RNA can be configured:
List of cells:
   UE is provided an explicit list of cells (one or more) that constitute the RNA;
List of RAN areas:
   A UE is provided (at least one) RAN area ID, where a RAN area is a subset of a CN Tracking Area or equal to a CN Tracking Area. A RAN area is specified by one RAN area ID, which consists of a TAI and optionally a RAN area Code; and
   A cell broadcasts one or more RAN area IDs in the system information.

NG-RAN may provide different RNA definitions to different UEs but not mix different definitions to the same UE at the same time. A UE as described in the context of [7] supports all RNA configuration options listed above.

In summary, as described in [7], the RRC_INACTIVE state can be characterised by:
Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for UE;
The UE AS context is stored in NG-RAN and the UE; and
NG-RAN knows the RNA which the UE belongs to.

The RNA configured for a UE may cover either a single cell, or multiple cells, and may be smaller than the core network area. An RNA update (RNAU) is transmitted by the UE to the network periodically, and also when the UE's cell reselection procedure selects a cell outside of the configured RNA.

### Sidelink Relay

As mentioned above, the introduction of a wide range of new device types and capabilities in NR creates technical challenges in maintaining device connectivity with a wireless communications network. One aspect of NR currently under development of the 3GPP group is that of the sidelink relay, which is discussed in 3GPP Release-17. For example, 3GPP study item [8] discusses a single-hop NR sidelink-based relay, which relays signals between two remote UEs to each of which it is connected via a PC5 interface. In particular, [8] targets:
Study mechanism(s) with minimum specification impact to support Service and System Aspect (SA) requirements for sidelink-based UE-to-network and UE-to-UE relay, focusing on the following aspects (if applicable) for layer-3 relay and layer-2 relay [RAN2];
   Relay (re-)selection criterion and procedure;
   Relay/Remote UE authorisation;
   QoS for relaying functionality;
   Service continuity;
   Security of relayed connection after SA3 has provided its conclusions; and
   Impact on user plane protocol stack and control plane procedure, e.g., connection management of relayed connection; and
Study mechanism(s) to support upper layer operations of discovery model/procedure for sidelink relaying, assuming no new physical layer channel/signal [RAN2].

It is noted in [8] that it is expected that UE-to-network relays and UE-to-UE relays will use the same relaying solution, and that forward compatibility for multi-hop relay support in future releases of standards should be taken into account. It is also noted in [8] that, for layer-2 UE-to-network relays, the architecture of end-to-end Packet Data Convergence Protocol (PDCP) and hop-by-hop Radio Link Control (RLC), as recommended in [9], is taken as a starting point.

### Paging Early Indication (PEI)

A Paging Early Indication (PEI) is sent before an actual paging occasion (PO) (such as that shown between t1 to t2 in the example of FIG. 4) while the UE is in RRC_IDLE or RRC_INACTIVE state. A PEI is only sent once a UE has been allocated into one of a plurality of different paging subgroups. Sending PEIs is done for UE power-saving purposes, so that a given UE does not wake up on every PO, but only on those POs which may be relevant to one or more UEs of its paging subgroup. Both PEI and paging subgroups are described in detail in [10], from which much of the following description is reproduced.

As noted above, and as described in [10], PEIs may be used for UEs in RRC IDLE and RRC INACTIVE states in order to reduce power consumption at those UEs. If a PEI configuration is provided in system information, UEs in RRC_IDLE or RRC_INACTIVE states supporting PEI (except for those UEs expecting multicast session activation notifications) can monitor PEIs using PEI parameters also indicated in system information according to the procedure described below.

If lastUsedCellOnly is configured in system information of a cell, UEs monitor for PEIs in the cell only if such UEs most recently received an RRCRelease message without noLastCellUpdate indicated for that cell. As those skilled in the art would understand, if noLastCellUpdate is indicated (as being true), this means that the UE should only monitor for PEIs in the cell in which the RRCRelease message with noLastCellUpdate was received by the UE and not in another cell if the UE moves or reselect to that other cell. Otherwise (i.e. if lastUsedCellOnly is not configured in system information of the cell), UEs will monitor for PEIs in the camped cell. UEs monitor one PEI occasion per DRX cycle. A PEI occasion (PEI-O) is a set of PDCCH monitoring occasions (MOs) and can consist of multiple time slots (e.g. subframes or OFDM symbols) where PEIs can be sent.

If PEIs and subgrouping are configured, UEs monitoring the same PO can be divided into one or more subgroups, as noted above. With subgrouping, UEs monitors the associated PO if the corresponding bit for the subgroup to which the UE belongs is indicated as 1 by the PEI corresponding to its PO. The following parameters are used for the determination of subgroup ID:
subgroupsNumPerPO: total number of subgroups for both core network-assigned subgrouping (if any) and UE_ID-based subgrouping (if any) in a PO, which is broadcasted in system information;
subgroupsNumForUEID: number of subgroups for UE_ID based subgrouping in a PO, which is broadcasted in system information.

A particular UE's subgroup can be either assigned by the core network or can be formed based on UE_ID, as detailed in the bullets below:
If subgroupsNumForUEID is absent in subgroupConfig, the subgroup ID based on core network-assigned subgrouping, if available for the UE, is used in the cell;
If both subgroupsNumPerPO and subgroupsNumForUEID are configured, and subgroupsNumForUEID has the same value as subgroupsNumPerPO, the subgroup ID based on UE_ID based subgrouping is used in the cell; and
If both subgroupsNumPerPO and subgroupsNumForUEID are configured, and subgroupsNumForUEID<subgroupsNumPerPO:
   The subgroup ID based on core network-assigned subgrouping, if available for the UE, is used in the cell; or
   Otherwise, the subgroup ID based on UE_ID based subgrouping is used in the cell.

If a UE has no core network-assigned subgroup ID or does not support core network-assigned subgrouping, and there is no configuration for subgroupsNumForUEID, the UE always monitors the associated PO.

Paging with core network-assigned subgrouping is used in cells which support core network-assigned subgrouping. A UE supporting core network-assigned subgrouping in RRC_IDLE or RRC_INACTIVE states can be assigned a subgroup ID (between 0 to 7) by AMF through NAS signalling. UEs belonging to the assigned subgroup ID then monitor for their associated PEI which indicates the paged subgroup(s). Similarly, paging with UE_ID-based subgrouping is used in cells which support UE_ID based subgrouping.

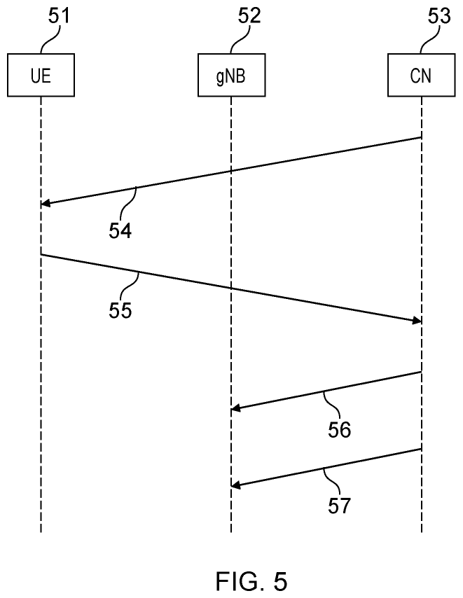

An example of core network assigned subgrouping is shown in FIG. 5, based on the behaviour already specified during Release-17. The core network 53 first transmits a NAS message 54 to a UE 51, which provides the UE 51 with its assigned paging subgroup ID. In response, the UE 51 transmits a second NAS message 55 to the core network 53, confirming that it has received the assigned paging subgroup ID. Here, this works for both core network-based paging subgroups and RAN-based paging subgroups, where information about such subgroups is provided in system information (e.g. in a SIB).

Following this, the core network 53 may transmit core network paging assistance information 56 to the RAN node which last served the UE 51—i.e. gNB 52. This core network paging assistance information 56 includes PEI assistance information, including the paging subgroup ID of the UE 51 and indeed one or more other UEs too (e.g. which are in the RRC_INACTIVE state). The core network paging assistance information 56 may further include information such as initial context setup request messages, UE context modification request messages, handover request messages, and path switch acknowledgement; all of which are only applicable for UEs in the RRC_INACTIVE state.

At a later point in time, when the core network 53 wishes to page one or more UEs for which gNB 52 was the last serving RAN node, it transmits a paging message 57 to the gNB 52 with an indication of the paging subgroup ID associated with those one or more UEs it wishes to page.

The support of PEI for sidelink relays has been discussed, for example in [11]. However, it was proposed in [11] that support of PEI shouldn't apply for sidelink relays, due to the existence of scenarios where one or more UEs support PEI and one or more other UEs do not.

It is acknowledged by the present inventors however that, clearly, it would be beneficial—at least in terms of power saving for sidelink relay UEs (especially where such sidelink relay UEs are in RRC IDLE or RRC INACTIVE states)—for such sidelink relay UEs to support PEI.

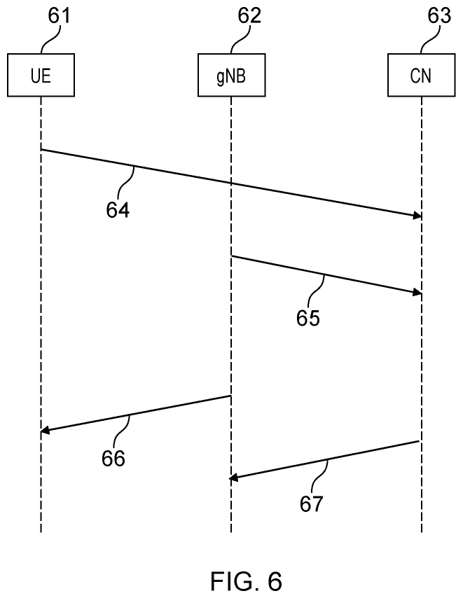

FIG. 6 shows an example of PEI and paging area signalling, following on from the messaging illustrated by FIG. 5. Once a UE 61 is informed about its paging group, either via core network or RAN-based methods, the next step is that the UE 61—while in the RRC_CONNECTED state—needs to inform the RAN (e.g. including gNB 62) regarding its UE radio paging capability. To do so, the UE 61 transmits such UE radio paging capability 64 to the core network 63 via gNB, where it is stored before being passed on by the core network 63 when transmitting paging messages 67 to further gNBs in order to assist the paging procedure. In the UE radio paging capability information 64, the UE 61 indicates its supported frequency bands for PEI subgroups.

When UE 61 is about to be moved to RRC_IDLE, the RAN node currently serving the UE 61 (e.g. gNB 62) informs the core network 63 of a list of RAN cells/nodes for paging, in UE context release complete message 65. The UE 61 is then informed regarding whether the PEI is valid in this cell (i.e. that controlled by gNB 62) only, or whether the PEI can be monitored for in neighbouring cells as well. This is done before the gNB 62 sends an RRCRelease message 66 to the UE 61 indicating that it is to move to the RRC IDLE state.

Normally two cases are specified for PEI:
PEI is supported across different cells, and this is determined based on a UE's capability to support PEI on different frequency bands. This capability is stored in the core network (after being indicated to the core network as shown by message 64 in the example of FIG. 6) and is passed on to gNBs when the core network transmits paging messages to those gNBs. RAN nodes (i.e. gNBs) will then pick cells/other RAN nodes for paging based on the list provided by the UE's source cell (i.e. gNB 62 in the example of FIG. 6) in the UE context release complete message. This information is also received by gNBs in the paging messages; or
PEI is supported only on the cell where UE received the RRCRelease message. In this case, the serving gNB informs the core network about the RAN nodes for paging as the current cell only. If, for example, paging fails (i.e. the core network does not receive a paging response after transmitting a paging message), and the UE has moved out of the cell, then, as part of failure handling, the core network will extend the paging area to other cells.

If a UE is behind a sidelink relay UE (i.e. is only connected to the RAN node via that sidelink relay UE), then it becomes necessary to change some of these procedures (e.g. those shown in the examples of FIGS. 5 and 6) in order to maintain support of PEI and paging subgroups for both sidelink relay UEs and the remote UEs connected to those sidelink relay UEs. Embodiments of the present technique therefore seek to provide solutions to address such support of PEI for scenarios involving sidelink relay UEs.

### PEI for SL Relays and Remote UE's Paging Subgroup and Last Cell Information

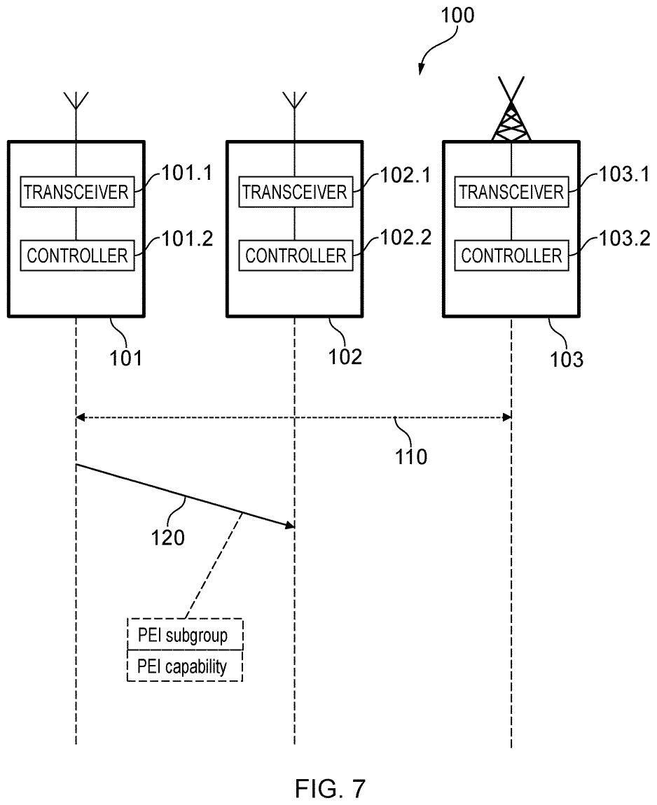

FIG. 7 shows a part schematic, part message flow diagram representation of a communications system 100 comprising a first (remote) communications device (e.g. UE) 101, a second communications device (e.g. UE) 102, and an infrastructure equipment (e.g. gNB) 103 in accordance with at least some embodiments of the present technique, where the second communications device 102 is operating as a relay device for the first communications device 101. Those skilled in the art would appreciate that the communications system 100 may comprise a great number more communications devices to those shown, including for example a plurality of communications device which may each be operating as relay devices for one or more remote communications devices, though such further communications devices are not shown in FIG. 7 for the purposes of simplicity. The communications system 100 may also comprise one or more further infrastructure equipment (e.g. gNBs) together forming a radio access network (RAN) with the infrastructure equipment (e.g. gNB) 103, although these are not shown in FIG. 7. Likewise, the communications system 100 may also comprise a core network part, though this is also not shown in FIG. 7.

The first communications device 101 may be configured to transmit signals to and/or receive signals from the second communications device 102, which may operate as a relay device for the first communications device 101. Specifically, the first communications device 101 may be configured to transmit data to and/or receive data from the second communications device via a sidelink (i.e. PC5) interface between the first communications device 101 and the second communications device 102. The second communications device 102 may be configured to communicate, additionally, with the infrastructure equipment 103, by transmitting signals to and/or receiving signals from the infrastructure equipment 103 via a wireless radio (e.g. Uu) interface provided by the infrastructure equipment 103. The first communications device 101 may be capable of communicating directly with the infrastructure equipment 103 via the Uu interface, but in the example of FIG. 7, communicates with the infrastructure equipment via the second (sidelink relay) communications device 102 since it may be in poor coverage, for example. The first communications device 101 (as well as second communications device 102 and infrastructure equipment 103) may also be configured to exchange signalling with the core network as would be well understood by those skilled in the art, although in the interests of simplicity this is not shown in FIG. 7.

The first communications device 101, the second communications device 102, and the infrastructure equipment 103, as shown in FIG. 7 (and indeed those communications devices and infrastructure equipment not shown in FIG. 7), may each comprise a transceiver (or transceiver circuitry) 101.1, 102.1, 103.1, and a controller (or controller circuitry) 101.2, 102.2, 103.1. Each of the controllers, such as controllers 101.2, 102.2, 103.3 may be, for example, a microprocessor, a CPU, or a dedicated chipset, etc.

As shown in the example of FIG. 7, the transceiver circuitry 101.1 and the controller circuitry 101.2 of the first communications device 101 are configured in combination to transmit 110 signals to and/or receive 110 signals from the infrastructure equipment 103 via the second communications device 102 operating as a relay device to which the first communications device is connected via a sidelink (e.g. PC5) communications interface, and to transmit 120, to the second communications device 102, an indication of at least one of a Paging Early Indication, PEI, subgroup of the first communications device 101 and a PEI capability of the first communications device 101. Here, the PEI subgroup of the first communications device 101 indicates paging occasions before which the first communications device 101 is configured to monitor for PEI signals (either originating from the infrastructure equipment 103 or the core network), the PEI signals each indicating whether the first communications device 101 is to monitor for paging signals (again, either originating from the infrastructure equipment 103 or the core network during the paging occasion following that PEI. The PEI subgroup may be a RAN-based paging subgroup or a core network-based paging subgroup. Furthermore, here, the PEI capability of the first communications device 101 indicates one or more frequency bands (such as the frequency band of the cell operated by the infrastructure equipment 103 and frequency bands of cells operated by other, not shown, infrastructure equipment) within which the first communications device 101 is able to receive PEI signals.

In other examples to that shown by FIG. 7, in accordance with embodiments of the present technique, it may be the communications network (e.g. the infrastructure equipment 103) that is configured to transmit to a communications device (e.g. second communications device 102) which is operating as a relay device and configured to relay signals between the infrastructure equipment and one or more remote communications devices (including first communications device 101), an indication of at least one of a PEI subgroup of at least one of the remote communications devices (including the first communications device 101) and a PEI capability of at least one of the remote communications devices (including the first communications device 101). Here, the network (e.g. infrastructure equipment 103) may send the PEI information of the remote communications devices (including the first communications device 101) to the relay (e.g. second) communications device 102 before—or indeed instead of—transmitting such PEI information to the remote communications devices (including the first communications device 101) at all, and it is up to the relay communications device 102 to forward this information onto the remote communications devices. In other examples, the remote communications device(s) might already know its PEI information (e.g. having received it from the infrastructure equipment 103 or a previous relay UE) and so the infrastructure equipment 103 simply transmits this information to the new relay UE (e.g. second communications device 102). In either case, such PEI information of the remote communications device(s) may be transmitted by the infrastructure equipment 103 to relay communications device 102 at any suitable time, such as when the infrastructure equipment 103 determines that the remote communications device(s) has reselected to that relay communications device 102, or upon any change in the PEI information for the remote communications device(s).

Essentially, embodiments of the present technique therefore propose that a remote UE shares its PEI information (such as its PEI subgroup for either RAN-based or core network-based paging or its PEI capability) with the sidelink relay UE to which it is connected, or that a gNB shares such PEI information of one or more remote UEs with a relay UE to which they are connected. Such PEI information will then enable the sidelink relay UE to know what PEI signals (and subsequent paging occasions) to monitor on behalf of the remote UE(s) to which it provides connectivity from the network. There are a number of different scenarios for how such PEI information is exchanged and used, for example, dependent on the RRC states of the remote UE and relay UE, as well as on the mobility of these remote and relay UEs, and on the basis of other information (such as for example the setting of noLastCellUpdate) related to those remote and relay UEs.

In a first scenario, where no changes are necessary to the known procedures, a relay UE may be operating in a connected mode with the network (e.g. RRC_CONNECTED) before then moving to an idle or inactive mode (e.g. RRC_IDLE or RRC_INACTIVE), where, here, remote UEs are not taken into account. Here, the relay UE will follow the procedure as shown in FIGS. 5 and 6 as described above.

That is, the relay UE will receive an indication of its PEI/paging subgroup either in a NAS message or via system information. In other words, the second (i.e. relay) communications device may be configured to receive, from a radio access network part of the communications network, system information comprising an indication of at least one of the PEI subgroup of the second communications device and the PEI capability of the second communications device, or the second (i.e. relay) communications device may be configured to receive, from a core network part of the communications network, Non-Access Stratum, NAS, signalling comprising an indication of at least one of the PEI subgroup of the second communications device and the PEI capability of the second communications device.

Likewise, the remote UE receives an indication of its own PEI information in the same manner. That is, the first (i.e. remote) communications device may be configured to receive, from a radio access network part of a communications network, system information comprising an indication of at least one of the PEI subgroup of the first communications device and the PEI capability of the first communications device, or the first (i.e. remote) communications device may be configured to receive, from a core network part of a communications network, Non-Access Stratum, NAS, signalling comprising an indication of at least one of the PEI subgroup of the first communications device and the PEI capability of the first communications device.

When the relay UE then moves to the idle or inactive mode, the gNB will receive core network paging with an indication of the PEI subgroup ID. The core network can send paging messages to selected gNB cells or RAN nodes. Here, the gNB is configured with subgroup information and, based on this information, the gNB will be able to pages a specific UE in its subgroup paging occasion.

However, when remote UEs are taken into account, as described in the various scenarios below, it is necessary for the PEI information of those remote UEs to be shared with the relay UE, as explained above. As such, the procedures as shown in FIGS. 5 and 6 as described above will need to be changed.

In accordance with some arrangements of embodiments of the present technique, a relay UE and a remote UE connected to that relay may both be in connected mode, before the remote UE then moves to idle mode. In this case, the remote UE shall receive a core network subgroup or UE ID subgroup based on either NAS signalling or system information as described above. This information is required to be sent over the PC5 interface from the relay UE to the remote UE, or may be exchanged over the Uu interface if the remote UE is in coverage and able to communicate directly with the RAN node/gNB. It may be the case however that the remote UE is out of coverage, and in such a case the only path to the RAN node is via the relay UE. In this case, PC5 signalling may pass the information from SIB/RRC/NAS signalling between the remote UE and the relay UE.

For the in-coverage case, once the remote UE moves to idle mode and there is a paging message intended for the remote UE, in order for the core network to send this paging message to the relay UE, the core network will first send the paging message to the gNB to which the relay UE is connected. If the relay UE is in connected mode, it will receive paging messages destined for its remote UE(s) based on an earlier-agreed design principle that remote UEs share their POs with their sidelink relays so that the sidelink relay UE is able to monitor for paging messages for the remote UE. In other words, the first (i.e. remote) communications device may be configured to transition from a connected state with a communications network to either an idle state, and subsequently to receive, from the second (i.e. relay) communications device while the first communications device is in the idle state, PEI signals and paging signals for the first communications device, the PEI signals and the paging signals being forwarded by the second communications device from the communications network. As those skilled in the art would appreciate, the RRC states (i.e. the connected, inactive, and idle states) are associated with Uu interfaces between UEs and RAN nodes, there is no change to a remote UE's sidelink (i.e. via PC5 interface) connection with a relay UE when that remote UE moves from one RRC state to another. Therefore, the PEI information (such as PEI subgroup and PEI capability) of the remote UE can be transmitted by the remote UE to the relay UE at any time, e.g. before transition to a new (e.g. idle) RRC state, after that transition, or indeed at the same time as that transition.

However, if the relay UE is not aware of the remote UE's PEI subgroup, then the relay UE will unnecessarily monitor all POs of the remote UE, which will result in wasted power consumption at the remote UE. So, in accordance with embodiments of the present technique as described above with respect to FIG. 7, the remote UE will inform the relay UE of its PEI subgroup and its PEI capability (i.e. supported frequency band(s)). The relay UE, based on this information, will then be able to decide to monitor for and receive PEI signals/paging messages only on certain PEI POs for this remote UE.

On the question of why PEI (frequency band) capability information needs to be informed to the relay UE by the remote UE, it is envisaged that PC5 interfaces might operate on unlicensed bands, while Uu interfaces operate on licensed bands, where both of these bands cannot co-exist in some UEs (i.e. such UEs support only one frequency band for PEI). Or, more simply put, a remote UE may not support PEI on the frequency of some cells. The relay UE needs to know the PEI capability information of the remote UE so that it stops monitoring for PEI signals for the remote UE from cells having frequency bands within which the remote UE does not support PEI (if this is the case) when the relay UE moves to or reselects such cells. In other words, the second (i.e. relay) communications device may be configured to reselect from a first cell of the communications network to a second cell of the communications network, and to determine, based on the PEI capability of the first (i.e. remote) communications device, whether the first communications device is able to receive PEI signals within a frequency band of the second cell.

In other arrangements, it may be the remote UE that moves to or reselects a new cell, and therefore may be required to change the sidelink relay UE to which it is connected-because it is agreed in 3GPP that the serving call of the remote UE cannot be different to that of the relay UE to which it is connected. The remote UE may also change relay UE for other reasons, such as one or both of the remote UE and relay UE having moved apart or moved such that they are now separated by obstacles causing unacceptable path loss, or there is another relay UE which provides a higher strength/quality connection for the remote UE available. However, the remote UE may not support PEI in the new cell, or via the new relay UE because now the frequency used for the sidelink between the remote UE and new relay UE is an unlicensed band, and therefore, this is something that the new relay UE will be able to determine from the remote UE's PEI capability upon the remote UE transmitting its PEI information to the new relay UE.

Here, if the second (i.e. relay) communications device determines that the first (i.e. remote) communications device is able to receive PEI signals within the frequency band of the second cell, the second communications device may be further configured, while the first communications device is in the idle state or the inactive state, to receive PEI signals from the second cell, the PEI signals being for communications devices belonging to the PEI subgroup of the first communications device, to receive paging signals from the second cell in accordance with the received PEI signals, the paging signals being for communications devices belonging to the PEI subgroup of the first communications device, and to transmit, to the first communications device, the received PEI signals and the received paging signals. However, if the second (i.e. relay) communications device determines that the first (i.e. remote) communications device is not able to receive PEI signals within the frequency band of the second cell, the second communications device may be further configured, while the first communications device is in the idle state or the inactive state, to monitor all paging occasions for paging signals for the first communications device received from the second cell, and to transmit, to the first communications device, the received paging signals.

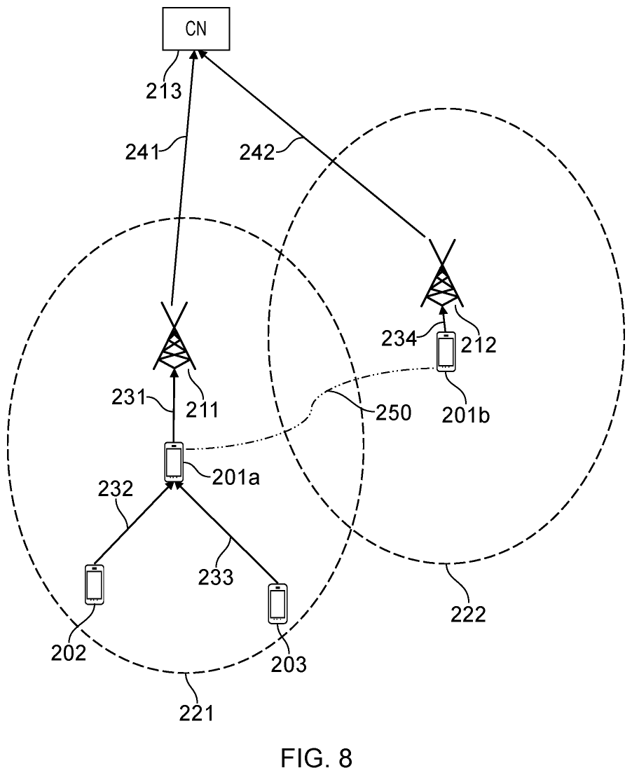

FIG. 8 shows a deployment scenario with different PEI capabilities for different UEs in accordance with embodiments of the present technique. In the example of FIG. 8, there are two gNBs 211, 212, each controlling a respective cell 221, 222. The gNBs 211, 212 may each be configured to communicate with the core network 213, as well as a number of UEs 201, 202, 203. UEs 202, 203 are remote UEs which may be on the edge of the coverage area of the cell 221 of a first of the gNBs 211, and therefore are connected to that gNB 211 via relay UE 201, which is initially within the first cell 221 denoted by position 201a. At a later point in time, the relay UE 201 may move 250 to the second cell 222 controlled by the second gNB 212, as denoted by position 201b.

In the example deployment scenario illustrated by FIG. 8, the relay UE 201 may be aware of the remote UEs 202, 203 supporting PEI in the first cell 221. But when the relay UE 201 moves 250 to the second cell 222, it will presently still expect a PEI before a paging occasion for the remote UEs 202, 203 which is provides connectivity to. However, if one or more of the remote UEs 202, 203 do not support PEI in the frequency band of the second cell 222, then the gNB 212 controlling the second cell 222 will never send PEI signals before paging messages (since it knows that the remote UEs 202, 203 do not support PEI in the second cell 222), and therefore the relay UE 201 will miss the paging occasions and hence paging for the remote UEs 202, 203 as it will never wake up to monitor those paging occasions due to never receiving any PEI signals. This is not an issue for paging messages/PEI signals sent over the Uu interface, because remote UEs knows their capabilities, and gNBs receive an indication of the UE's capability for PEI included in the paging message-it is the relay UE which is not aware of this information. Here, it should be noted, as described above, that those skilled in the art would appreciate that it is agreed in 3GPP that the serving cell of a relay UE and remote UEs connected to that relay UE cannot be different.

In view of the above, in some arrangements of embodiments of the present technique, the UE context release complete message, sent from the serving gNB to the core network for relay UEs which were in the connected mode and then moved to either idle/inactive mode (and where their associated remote UEs are also in the same RRC state), includes both the relay UE's ID and remote UE's or UEs' IDs, where these remote UE(s) are those associated with (i.e. connected to the network via) this relay UE. In other words, the infrastructure equipment (i.e. gNB) may be configured to transmit, to a communications device (i.e. relay UE), a command for the communications device to transition from a connected state with the infrastructure equipment to either an idle state or an inactive state (wherein the communications device is operating as a relay device and configured to relay signals between the infrastructure equipment and one or more remote communications devices) to release (if the relay UE is moving to the idle state) or to suspend (if the relay UE is moving to the inactive state) a connection with the communications device, and to transmit, to a core network part of the communications network, an identifier associated with the communications device, an identifier of each of the one or more remote communications devices, and an indication that the communications device is operating as a relay device for the one or more remote communications devices.

This can also be understood with reference to FIG. 8. As shown in FIG. 8, each remote UE 202, 203 transmits an indication of its PEI information (e.g. PEI subgroup) 232, 233 to the relay UE 201, which then forwards 231 this information (along with its own PEI information (e.g. PEI subgroup) to the first gNB 211. In turn, the first gNB 211 can indicate 241 to the core network 213 the IDs of the relay UE 201 and the remote UEs 202, 203, as well as the association between the relay UE 201 and the remote UEs 202, 203. When the relay UE 201 later moves 250 to position 201b, only the second remote UE 203 remains in range of it. Therefore, the relay UE 201 at position 201b after moving 250 transmits an indication 234 of its PEI information (e.g. PEI subgroup) and the second remote UE's 203 PEI information (e.g. PEI subgroup) to the second gNB 212. The second gNB 212 can then indicate 242 to the core network 213 the IDs of the relay UE 201 and the second remote UE 203, as well as the association between the relay UE 201 and the second remote UE 203.

In this (or in other examples) the gNB may decide to transmit (for storage) the PEI information of one or more remote UEs (either with or without an indication that they are served by a particular relay UE) to the core network. In other words, the infrastructure equipment may be configured to transmit, to a core network part of the communications network, an indication of the PEI subgroup of the at least one remote communications device and/or an indication of the PEI capability of the at least one remote communications device.

In accordance with some arrangements of embodiments of the present technique, a relay UE may be in connected mode, while a remote UE connected to that relay may be in inactive mode, or may initially be in connected mode before moving to inactive mode. Here, in this case, only RAN paging can be carried out. The gNB may page here based on PEI as described above, and the relay UE will monitor specific PEI paging occasions. In other words, the first (i.e. remote) communications device may be configured to transition from a connected state with a communications network to an inactive state, and subsequently to receive, from the second (i.e. relay) communications device while the first communications device is in the inactive state, PEI signals and paging signals for the first communications device, the PEI signals and the paging signals being forwarded by the second communications device from the communications network.

In accordance with some arrangements of embodiments of the present technique, a relay UE may in the inactive state, with a remote UE connected to that relay UE also being in the inactive state. It is agreed within 3GPP that both relay and remote UE have the same RAN notification area (RNA). The remote UE knows, based on the signalling received from the relay UE, that the relay UE has moved to a different cell or even that the RNA has changed. Since the relay UE is aware of the remote UE's PEI subgroup and capability, based on arrangements of embodiments of the present technique explained above, the relay UE will monitor for PEI signals for the remote UE. If the remote UE is no longer capable of receiving PEI (due to that remote UE's PEI capability indicating that it does not support PEI on the frequency band of a new cell to which the relay UE moves), then the relay UE will monitor all POs for this remote UE.

Similarly to this scenario, if both the relay and remote UEs are in the idle state, and both happen to be in the same tracking area (TA), then there is no new issue differing to the above-described arrangements relating to cell or RNA change where both relay and remote UEs are in the inactive state, and so arrangements of embodiments of the present technique may be applied in the same way.

In accordance with some arrangements of embodiments of the present technique, a remote UE may be located in a cell edge area of first cell, and the relay UE to which it is connected may move from that first cell to a second cell. The relay UE here has “noLastCellUpdate” set as false (e.g. it is a moving relay and therefore capable of receiving PEI in the new second cell), but the remote UE has “noLastCellUpdate” set as true (i.e. the remote UE is a static UE and is only able to receive PEI from the first cell). The remote UE here may also be in idle or inactive state. In this case, in accordance with such embodiments, the remote UE may ask the relay UE to stop using PEI for receiving its paging messages if and when the relay UE moves from the first cell and camps on the new second cell. In other words, the first (i.e. remote) communications device may be configured, while it is in either an idle state or an inactive state, to determine that the first communications device is to only monitor for PEI signals from a first cell of a communications network, wherein the first communications device was in a connected state with the first cell via the second communications device before transitioning to the idle state or the inactive state, and to transmit, to the second communications device, an indication that the second communications device is not to monitor for PEI signals for the first communications device if the second communications device reselects from the first cell to a second cell of the communications network.

In accordance with some arrangements of embodiments of the present technique, a remote UE may be located in a cell edge area of first cell, and the relay UE to which it is connected may move from that first cell to a second cell. The relay UE here has “noLastCellUpdate” set as true (e.g. it is a fixed relay UE which has simply carried out a cell reselection as, for example, it is located in a crossover region where it is capable of receiving signals from both the first and second cells, and the relay UE is only capable of receiving PEI from the first cell). However, the remote UE here may have “noLastCellUpdate” set as false (i.e. the remote UE is capable of receiving PEI from both the current first cell and the new second cell). Again, the remote UE here may be in idle or inactive state. In this case, in accordance with such embodiments, the relay UE may determine that it has to monitor all paging occasions for paging messages for the remote UE (i.e. to ignore the remote UE's PEI capability) and decide that it is better to inform gNB that the remote UE—while actually capable of PEI reception in the new second cell where it is the relay UE that is not capable—does not use PEI. The relay UE would also do the same if “noLastCellUpdate” was set as true for both the relay UE and the remote UE. In other words, the second (i.e. relay) communications device may be configured to reselect from a first cell of the communications network to a second cell of the communications network, to determine that the second communications device (and in some cases, also the first (i.e. remote) communications device) is to only monitor for PEI signals from the first cell, and subsequently to monitor all paging occasions for paging signals for the first communications device received from the second cell, and to transmit, to the first communications device, the received paging signals.

Alternatively, while not capable of supporting PEI in the new cell itself, the relay UE is still capable of handling PEI for remote UEs, as the remote UE informs its PEI subgroups (i.e. paging occasions) and capability to the relay UE—i.e. “noLastCellUpdate” is set as true for the relay UE but false for the remote UE. Here, the relay UE would still monitor for PEI for the remote UE's subgroup's paging occasions for this remote UE. In other words, the second (i.e. relay) communications device may be configured to reselect from a first cell of the communications network to a second cell of the communications network, to determine that the second communications device is only to monitor for PEI signals for the second communications device from the first cell but that the second communications device is to monitor for PEI signals for the first (i.e. remote) communications device from both the first cell and the second cell, and subsequently to receive PEI signals from the second cell, the PEI signals being for communications devices belonging to the PEI subgroup of the first communications device, to receive paging signals from the second cell in accordance with the received PEI signals, the paging signals being for communications devices belonging to the PEI subgroup of the first communications device, and to transmit, to the first communications device, the received PEI signals and the received paging signals.

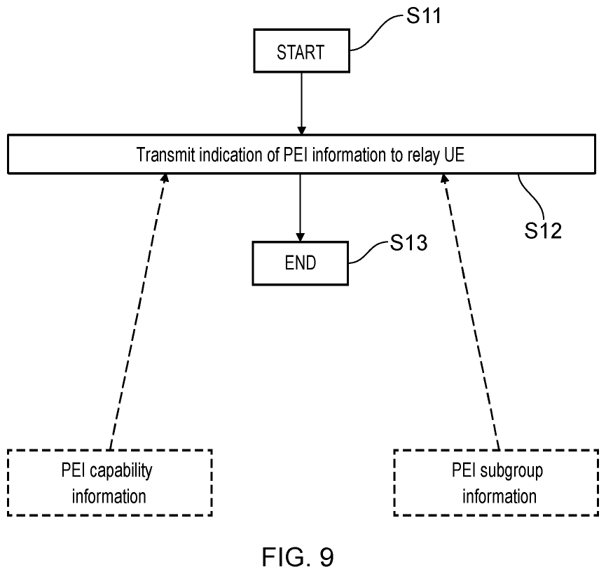

FIG. 9 shows a flow diagram illustrating a first example process of communications in a communications system in accordance with embodiments of the present technique. The process shown by FIG. 9 is a method of operating a first communications device.

The method begins in step S11. The method comprises, in step S12, transmitting, to a second communications device operating as a relay device to which the first communications device is connected via a sidelink communications interface, an indication of at least one of a Paging Early Indication, PEI, subgroup of the first communications device and a PEI capability of the first communications device.

Here, the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals. The process ends in step S13.

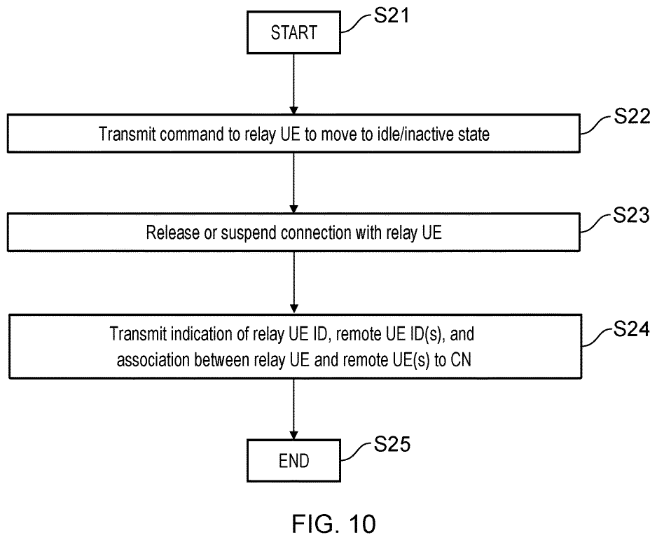

FIG. 10 shows a flow diagram illustrating a second example process of communications in a communications system in accordance with embodiments of the present technique. The process shown by FIG. 10 is a method of operating an infrastructure equipment forming part of a communications network.

The method begins in step S21. The method comprises, in step S22 transmitting, to a communications device, a command for the communications device to transition from a connected state with the infrastructure equipment to either an idle state or an inactive state, wherein the communications device is operating as a relay device and configured to relay signals between the infrastructure equipment and one or more remote communications devices. In step S23, the method comprises releasing (if the communications device is to transition to the idle state) or suspending (if the communications device is to transition to the inactive state) a connection with the communications device. Then, in step S24, the process comprises transmitting, to a core network part of the communications network, an identifier associated with the communications device, an identifier of each of the one or more remote communications devices, and an indication that the communications device is operating as a relay device for the one or more remote communications devices. The process ends in step S25.

Those skilled in the art would appreciate that the methods shown by FIG. 9 or 10 may be adapted in accordance with embodiments of the present technique. For example, other intermediate steps may be included in these methods, or the steps may be performed in any logical order. Though embodiments of the present technique have been described largely by way of the example communications systems shown in FIG. 7 and the deployment scenario illustrated by FIG. 8, it would be clear to those skilled in the art that they could be equally applied to other systems and scenarios to those described herein. Where paging is referred to in the present disclosure, this may refer to either or both of core network-based paging and RAN-based paging, where the type of paging may depend on, for example, the RRC states of the UEs involved (e.g. for a UE in RRC_INACTIVE, the paging may be RAN-based paging, while for a UE in RRC_IDLE, the paging may be core network-based paging).

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a first communications device, the method comprising
transmitting, to a second communications device operating as a relay device to which the first communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 2. A method according to Paragraph 1, comprising
receiving, from a radio access network part of a communications network, system information comprising an indication of at least one of the PEI subgroup of the first communications device and the PEI capability of the first communications device.

Paragraph 3. A method according to Paragraph 1 or Paragraph 2, comprising
receiving, from a core network part of a communications network, Non-Access Stratum, NAS, signalling comprising an indication of at least one of the PEI subgroup of the first communications device and the PEI capability of the first communications device.

Paragraph 4. A method according to any of Paragraphs 1 to 3, comprising
transitioning from a connected state with a communications network to either an idle state or an inactive state, and subsequently
receiving, from the second communications device while the first communications device is in the idle state or the inactive state, PEI signals and paging signals for the first communications device, the PEI signals and the paging signals being forwarded by the second communications device from the communications network.

Paragraph 5. A method according to any of Paragraphs 1 to 4, comprising, while the first communications device is in either an idle state or an inactive state,
determining that the first communications device is to only monitor for PEI signals from a first cell of a communications network, wherein the first communications device was in a connected state with the first cell via the second communications device before transitioning to the idle state or the inactive state, and
transmitting, to the second communications device, an indication that the second communications device is not to monitor for PEI signals for the first communications device if the second communications device reselects from the first cell to a second cell of the communications network.

Paragraph 6. A first communications device comprising
transceiver circuitry, and
controller circuitry configured in combination with the transceiver circuitry
to transmit to a second communications device operating as a relay device to which the first communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 7. Circuitry for a first communications device comprising
transceiver circuitry, and
controller circuitry configured in combination with the transceiver circuitry
to transmit to a second communications device operating as a relay device to which the first communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 8. A method of operating a second communications device as a relay device, the method comprising
receiving, from either a communications network or a first communications device to which the second communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 9. A method according to Paragraph 8, comprising
determining that the first communications device has transitioned from a connected state with the communications network to either an idle state or an inactive state, and subsequently
receiving PEI signals from the communications network, the PEI signals being for communications devices belonging to the PEI subgroup of the first communications device,
receiving paging signals from the communications network in accordance with the received PEI signals, the paging signals being for communications devices belonging to the PEI subgroup of the first communications device, and
transmitting, to the first communications device, the received PEI signals and the received paging signals.

Paragraph 10. A method according to Paragraph 8 or Paragraph 9, comprising
reselecting from a first cell of the communications network to a second cell of the communications network, and
determining, based on the PEI capability of the first communications device, whether the first communications device is able to receive PEI signals within a frequency band of the second cell.

Paragraph 11. A method according to Paragraph 10, wherein if the second communications device determines that the first communications device is able to receive PEI signals within the frequency band of the second cell, the method further comprises, while the first communications device is in the idle state or the inactive state,
receiving PEI signals from the second cell, the PEI signals being for communications devices belonging to the PEI subgroup of the first communications device,
receiving paging signals from the second cell in accordance with the received PEI signals, the paging signals being for communications devices belonging to the PEI subgroup of the first communications device, and
transmitting, to the first communications device, the received PEI signals and the received paging signals.

Paragraph 12. A method according to Paragraph 10 or Paragraph 11, wherein if the second communications device determines that the first communications device is not able to receive PEI signals within the frequency band of the second cell, the method further comprises, while the first communications device is in the idle state or the inactive state,
monitoring all paging occasions for paging signals for the first communications device received from the second cell, and
transmitting, to the first communications device, the received paging signals.

Paragraph 13. A method according to any of Paragraphs 8 to 12, comprising
receiving, from the first communications device while the first communications device is in either an idle state or an inactive state, an indication that the second communications device is not to monitor for PEI signals for the first communications device if the second communications device reselects from a first cell of the communications network to a second cell of the communications network.

Paragraph 14. A method according to any of Paragraphs 8 to 13, comprising
reselecting from a first cell of the communications network to a second cell of the communications network,
determining that the second communications device is to only monitor for PEI signals from the first cell, and subsequently
monitoring all paging occasions for paging signals for the first communications device received from the second cell, and
transmitting, to the first communications device, the received paging signals.

Paragraph 15. A method according to any of Paragraphs 8 to 14, comprising
reselecting from a first cell of the communications network to a second cell of the communications network,
determining that the second communications device is only to monitor for PEI signals for the second communications device from the first cell but that the second communications device is to monitor for PEI signals for the first communications device from both the first cell and the second cell, and subsequently
receiving PEI signals from the second cell, the PEI signals being for communications devices belonging to the PEI subgroup of the first communications device,
receiving paging signals from the second cell in accordance with the received PEI signals, the paging signals being for communications devices belonging to the PEI subgroup of the first communications device, and
transmitting, to the first communications device, the received PEI signals and the received paging signals.

Paragraph 16. A second communications device operating as a relay device comprising
transceiver circuitry, and
controller circuitry configured in combination with the transceiver circuitry
to receive, from either a communications network or a first communications device to which the second communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 17. Circuitry for a second communications device operating as a relay device comprising
transceiver circuitry, and
controller circuitry configured in combination with the transceiver circuitry
to receive, from either a communications network or a first communications device to which the second communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

Paragraph 18. A method of operating an infrastructure equipment forming part of a communications network, the method comprising
transmitting, to a communications device which is operating as a relay device and configured to relay signals between the infrastructure equipment and one or more remote communications devices, an indication of at least one of a Paging Early Indication, PEI, subgroup of at least one of the remote communications devices and a PEI capability of at least one of the remote communications devices,
wherein the PEI subgroup of the at least remote communications device indicates paging occasions before which the at least remote communications device is configured to monitor for PEI signals, the PEI signals each indicating whether the at least remote communications device is to monitor for paging signals during the paging occasion following that PEI, and
wherein the PEI capability of the at least remote communications device indicates one or more frequency bands within which the at least remote communications device is able to receive PEI signals.

Paragraph 19. A method according to Paragraph 18, comprising
transmitting, to a core network part of the communications network, an indication of the PEI subgroup of the at least one remote communications device and/or an indication of the PEI capability of the at least one remote communications device.

Paragraph 20. A method according to Paragraph 18 or Paragraph 19, comprising
transmitting, to the communications device, a command for the communications device to transition from a connected state with the infrastructure equipment to either an idle state or an inactive state,
releasing or suspending a connection with the communications device, and
transmitting, to a core network part of the communications network, an identifier associated with the communications device, an identifier of each of the one or more remote communications devices, and an indication that the communications device is operating as a relay device for the one or more remote communications devices.

Paragraph 21. An infrastructure equipment forming part of a communications network, the infrastructure equipment comprising
transceiver circuitry, and
controller circuitry configured in combination with the transceiver circuitry
to transmit, to a communications device which is operating as a relay device and configured to relay signals between the infrastructure equipment and one or more remote communications devices, an indication of at least one of a Paging Early Indication, PEI, subgroup of at least one of the remote communications devices and a PEI capability of at least one of the remote communications devices,
wherein the PEI subgroup of the at least remote communications device indicates paging occasions before which the at least remote communications device is configured to monitor for PEI signals, the PEI signals each indicating whether the at least remote communications device is to monitor for paging signals during the paging occasion following that PEI, and
wherein the PEI capability of the at least remote communications device indicates one or more frequency bands within which the at least remote communications device is able to receive PEI signals.

Paragraph 22. Circuitry for an infrastructure equipment forming part of a communications network, the infrastructure equipment comprising
transceiver circuitry, and
controller circuitry configured in combination with the transceiver circuitry
to transmit, to a communications device which is operating as a relay device and configured to relay signals between the infrastructure equipment and one or more remote communications devices, an indication of at least one of a Paging Early Indication, PEI, subgroup of at least one of the remote communications devices and a PEI capability of at least one of the remote communications devices,
wherein the PEI subgroup of the at least remote communications device indicates paging occasions before which the at least remote communications device is configured to monitor for PEI signals, the PEI signals each indicating whether the at least remote communications device is to monitor for paging signals during the paging occasion following that PEI, and
wherein the PEI capability of the at least remote communications device indicates one or more frequency bands within which the at least remote communications device is able to receive PEI signals.

Paragraph 23. A communications system comprising a first communications device according to Paragraph 6 and a second communications device operating as a relay device according to Paragraph 16.

Paragraph 24. A communications system according to Paragraph 23, comprising an infrastructure equipment according to Paragraph 21.

Paragraph 25. A computer program comprising instructions which, when loaded onto a computer, cause the computer to perform a method according to any of Paragraphs 1 to 5, any of Paragraphs 8 to 15, or any of Paragraphs 18 to 20.

Paragraph 26. A non-transitory computer-readable storage medium storing a computer program according to Paragraph 25.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### References

[1] Holma H. and Toskala a, “LTE for UMTS OFDMA and SC-FDMA based radio access”, John Wiley and Sons, 2009.
[2] TR 38.913, “3^{rd} Generation Partnership Project; Technical Specification Group Radio Access Network; Study on Scenarios and Requirements for Next Generation Access Technologies (Release 14)”, 3GPP, v14.3.0, August 2017.
[3] TS 38.470, 3^{rd} Generation Partnership Project; Technical Specification Group Radio Access Network; NG-RAN; F1 general aspects and principles (Release 17)”, 3GPP, v17.2.0, September 2022.
[4] TS 38.473, 3^{rd} Generation Partnership Project; Technical Specification Group Radio Access Network; NG-RAN; F1 application protocol (F1AP) (Release 17)”, 3GPP, v17.2.0, September 2022.
[5] 3GPP TS 36.304, “Evolved Universal Terrestrial Radio Access (E-UTRA); User Equipment (UE) procedures in idle mode”, 3rd Generation Partnership Project.
[6] 3GPP TS 36.321, “Evolved Universal Terrestrial Radio Access (E-UTRA); Medium Access Control (MAC) protocol specification”, 3rd Generation Partnership Project.
[7] TS 38.300, “NR and NG-RAN Overall Description; Stage 2 (Release 15)”, 3rd Generation Partnership Project.
[8] RP-193253, “New SID: Study on NR sidelink relay” (OPPO), December 2019.
[9] TR 36.746, “3^{rd} Generation Partnership Project; Technical Specification Group Radio Access Network; Study on further enhancements to LTE Device to Device (D2D), User Equipment (UE) to network relays for Internet of Things (IoT) and wearables; (Release 15) (version 15.1.1)” (3GPP Organisation), April 2018.
[10] 3GPP TS 38.304, “NR; User Equipment (UE) procedures in idle mode and in RRC Inactive state”, 3rd Generation Partnership Project.
[11] R2-2212426, “Coexistence of PEI in case of SL relay” (Ericsson), November 2022.

1. A method of operating a first communications device, the method comprising
transmitting, to a second communications device operating as a relay device to which the first communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

2. A method according to claim 1, comprising
receiving, from a radio access network part of a communications network, system information comprising an indication of at least one of the PEI subgroup of the first communications device and the PEI capability of the first communications device.

3. A method according to claim 1, comprising
receiving, from a core network part of a communications network, Non-Access Stratum, NAS, signalling comprising an indication of at least one of the PEI subgroup of the first communications device and the PEI capability of the first communications device.

4. A method according to claim 1, comprising
transitioning from a connected state with a communications network to either an idle state or an inactive state, and subsequently
receiving, from the second communications device while the first communications device is in the idle state or the inactive state, PEI signals and paging signals for the first communications device, the PEI signals and the paging signals being forwarded by the second communications device from the communications network.

5. A method according to claim 1, comprising, while the first communications device is in either an idle state or an inactive state,
determining that the first communications device is to only monitor for PEI signals from a first cell of a communications network, wherein the first communications device was in a connected state with the first cell via the second communications device before transitioning to the idle state or the inactive state, and
transmitting, to the second communications device, an indication that the second communications device is not to monitor for PEI signals for the first communications device if the second communications device reselects from the first cell to a second cell of the communications network.

6. A first communications device comprising
transceiver circuitry, and
controller circuitry configured in combination with the transceiver circuitry
to transmit to a second communications device operating as a relay device to which the first communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

7. (canceled)

8. A method of operating a second communications device as a relay device, the method comprising
receiving, from either a communications network or a first communications device to which the second communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

9. A method according to claim 8, comprising
determining that the first communications device has transitioned from a connected state with the communications network to either an idle state or an inactive state, and subsequently
receiving PEI signals from the communications network, the PEI signals being for communications devices belonging to the PEI subgroup of the first communications device,
receiving paging signals from the communications network in accordance with the received PEI signals, the paging signals being for communications devices belonging to the PEI subgroup of the first communications device, and
transmitting, to the first communications device, the received PEI signals and the received paging signals.

10. A method according to claim 8, comprising
reselecting from a first cell of the communications network to a second cell of the communications network, and
determining, based on the PEI capability of the first communications device, whether the first communications device is able to receive PEI signals within a frequency band of the second cell.

11. A method according to claim 10, wherein if the second communications device determines that the first communications device is able to receive PEI signals within the frequency band of the second cell, the method further comprises, while the first communications device is in the idle state or the inactive state,
receiving PEI signals from the second cell, the PEI signals being for communications devices belonging to the PEI subgroup of the first communications device,
receiving paging signals from the second cell in accordance with the received PEI signals, the paging signals being for communications devices belonging to the PEI subgroup of the first communications device, and
transmitting, to the first communications device, the received PEI signals and the received paging signals.

12. A method according to claim 10, wherein if the second communications device determines that the first communications device is not able to receive PEI signals within the frequency band of the second cell, the method further comprises, while the first communications device is in the idle state or the inactive state,
monitoring all paging occasions for paging signals for the first communications device received from the second cell, and
transmitting, to the first communications device, the received paging signals.

13. A method according to claim 8, comprising
receiving, from the first communications device while the first communications device is in either an idle state or an inactive state, an indication that the second communications device is not to monitor for PEI signals for the first communications device if the second communications device reselects from a first cell of the communications network to a second cell of the communications network.

14. A method according to claim 8, comprising
reselecting from a first cell of the communications network to a second cell of the communications network,
determining that the second communications device is to only monitor for PEI signals from the first cell, and subsequently
monitoring all paging occasions for paging signals for the first communications device received from the second cell, and
transmitting, to the first communications device, the received paging signals.

15. A method according to claim 8, comprising
reselecting from a first cell of the communications network to a second cell of the communications network,
determining that the second communications device is only to monitor for PEI signals for the second communications device from the first cell but that the second communications device is to monitor for PEI signals for the first communications device from both the first cell and the second cell, and subsequently
receiving PEI signals from the second cell, the PEI signals being for communications devices belonging to the PEI subgroup of the first communications device,
receiving paging signals from the second cell in accordance with the received PEI signals, the paging signals being for communications devices belonging to the PEI subgroup of the first communications device, and
transmitting, to the first communications device, the received PEI signals and the received paging signals.

16. A second communications device operating as a relay device comprising
transceiver circuitry, and
controller circuitry configured in combination with the transceiver circuitry
to receive, from either a communications network or a first communications device to which the second communications device is connected via a sidelink communications interface, an indication of at least one of a Paging Early Indication, PEI, subgroup of the first communications device and a PEI capability of the first communications device,
wherein the PEI subgroup of the first communications device indicates paging occasions before which the first communications device is configured to monitor for PEI signals, the PEI signals each indicating whether the first communications device is to monitor for paging signals during the paging occasion following that PEI, and
wherein the PEI capability of the first communications device indicates one or more frequency bands within which the first communications device is able to receive PEI signals.

17.-26. (canceled)
